(19) United States
(12) Patent Application Publication
(10) Pub. No.: US 2023/0116228 A1
(43) Pub. Date: Apr. 13, 2023

(54) SEEDING TRAY AND ACCESSORIES

(71) Applicant: Vego Garden Inc, Houston, TX (US)

(72) Inventor: Guangyuan Xiong, Houston, TX (US)

(21) Appl. No.: 17/964,241

(22) Filed: Oct. 12, 2022

Related U.S. Application Data
(60) Provisional application No. 63/254,612, filed on Oct. 12, 2021.

(51) Int. Cl. A01G 9/029

(52) U.S. Cl. CPC A01G 9/0295

(57) ABSTRACT

A seedling cube for growing seedlings, the seedling cube comprising a seedling tray having a plurality of cells and a branching table surrounded by the cells, and a cube lid having a water storage tank, which is configured to be disposed on top of the seedling tray.

### CROSS-REFERENCE TO RELATED PATENT APPLICATIONS

This application claims priority to and the benefit of U.S. Provisional Patent Application Ser. No. 63/254,612, filed Oct. 12, 2021, which is incorporated herein in its entirety by reference.

### FIELD OF THE INVENTION

The present disclosure relates generally to a seedling cube. In particular, the invention is directed to a seedling cube having a seedling tray and a cube lid and improving air and water ventilation/circulation for seedlings.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Seedlings are often started in trays or other containers containing soil or growing medium in which the seed germination starts. The seedlings will ultimately be transplanted to a larger container or to an outdoor garden when the seed germination and early development of the seedlings are accomplished. When the seedlings have grown to sufficient size within the container, at which time the roots may crowd together to form a plug in combination with the growing medium, the seedling plug is usually considered to be ready for transplanting into the garden beds.

Ventilation and humidity control is crucial during the seed germination and early development of the seedling. Though the seed germination and early development of the seedling require high humidity, an over high humidity may increase the microorganism growing in the soil and thus lead to rotten seedlings. In addition, when the humidity of the soil is high, the weight of the soil would increase significantly and thus may lead to the deformation or even destruction of the container.

Therefore, a need exists for a seedling container which improves the ventilation of the soil in which seedlings grow, as well as structural strength of the seedling container to prevent the deformation of the container.

### SUMMARY OF THE INVENTION

In light of the foregoing, this invention discloses a seedling cube including a seedling tray and a cube lid assembly and their application. The seedling cube has structures improving ventilation of air and circulation of water for the seedlings grown inside the seedling cube. The seedling cube has better strength to withhold the weight of the soil, water, and seedlings.

In one aspect of the invention, a seedling cube for growing seedlings, the seedling cube comprising a seedling tray having a plurality of cells, and a cube lid which is configured to be disposed on top of the seedling tray.

In one embodiment, each of the cells has at least one air pruning slot on wall of the cell.

In one embodiment, the air pruning slot comprises an elongated-shape hole extending from top portion of the cell to bottom portion of the cell.

In one embodiment, the air pruning slot comprises a plurality of dot-shape holes arranged in a line extending from top portion of the cell to bottom portion of the cell.

In one embodiment, each of the cells has four air pruning slots, wherein each of the air pruning clots locates near the corner of the cells.

In one embodiment, each of the cells further comprises at least one reinforce strip on the wall.

In one embodiment, each of the cells further comprises a drain hole on the bottom portion of the cell.

In one embodiment, the seedling tray further comprises a branching table in the center of the seedling tray and is surrounded by the cells; wherein the height of the branching table is lower than the height of the cells such that a recess space is formed above the branching table for receiving water.

In one embodiment, the seedling tray further comprises at least one branching channel, wherein the branching channel is in fluid communication with the branching table on one of its ends, and is in fluid communication with at least one cell on the other of its ends.

In one embodiment, the branching table is raised in the central area of its top surface such that water received on the branching table would automatically flow into the branching channel due to gravity.

In one embodiment, the branching table provides slow and continuous irrigation to the seedlings in the cells.

In one embodiment, the top surface of the branching table is symmetrical such that the water received on the branching table would be evenly distributed into all the cells.

In one embodiment, the cube lid comprises a water tank storage receiving water and a lid body.

In one embodiment, the water tank storage of the cube lid is configured to be vertically aligned with the branching table of the seedling tray when the seedling tray and the cube lid are coupled together.

In one embodiment, the water tank storage comprises a plurality of slits on its the bottom portion, wherein the water drips onto the branching table of the seedling tray through the plurality of slits on the water tank storage.

In another aspect of the invention, a stackable seedling tray, comprising a plurality of cells, a branching table in the center of the seedling tray and surrounded by the cells.

In one embodiment, each of the cells has at least one air pruning slot on wall of the cell.

In one embodiment, the air pruning slot comprises an elongated-shape hole extending from top portion of the cell to bottom portion of the cell.

In one embodiment, each of the cells further comprises at least one reinforce strip on the wall.

In one embodiment, each of the cells further comprises a drain hole on the bottom portion of the cell.

In one embodiment, the seedling tray is stackable.

These and other aspects of the present invention will become apparent from the following description of the preferred embodiments, taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 depicts a lateral top perspective view of a seedling tray according to embodiments of the invention.

FIG. 2 depicts a lateral bottom perspective view of the seedling tray shown in FIG. 1.

FIG. 3 depicts a side perspective view of the seedling tray shown in FIG. 1 with arrows showing ventilation.

FIG. 4 depicts a bottom perspective view of the seedling tray shown in FIG. 1.

FIG. 5 depicts a side perspective view of more than one seedling trays shown in FIG. 1 stacked together.

FIG. 6 depicts a perspective view of a cube lid for the seedling cube according to embodiments of the invention.

FIG. 7 depicts a top view of a water storage tank of the cube lid shown in FIG. 6.

FIG. 8 depicts a perspective view of a branching table of the seedling cube shown in FIG. 1.

FIG. 9 depicts a perspective view of the seedling cube including a seedling tray as shown in FIG. 1 coupled with the cube lid shown in FIG. 6.

FIG. 10 depicts a perspective view of the seedling cube with 4 cells.

FIG. 11 depicts a perspective view of the seedling tray with 4 cells shown in FIG. 10.

FIG. 12 depicts a perspective view of four seedling trays with 4 cells disposed in a flat tray.

FIG. 13 depicts another perspective view of four seedling trays with 8 cells disposed in a flat tray.

FIG. 14 depicts a perspective view of a flat tray.

FIG. 15 depicts another perspective view of the flat tray shown in FIG. 14.

FIG. 16 depicts a lateral perspective view of a seeder/popper panel.

FIG. 17 depicts a top perspective view of the seeder/popper panel shown in FIG. 16.

FIG. 18 depicts a perspective view of the seeder/popper panel shown in FIG. 16 in association with a seedling tray.

FIG. 19 depicts another perspective view of the seeder/popper panel shown in FIG. 16 in association with a seedling tray.

FIG. 20 depicts another perspective view of the seeder/popper panel shown in FIG. 16 in association with a seedling tray.

FIG. 21 depicts a perspective view of a supporting leg.

FIG. 22 depicts a perspective view of the supporting leg shown in FIG. 21 in association with seedling trays.

FIG. 23 depicts a top perspective view of another embodiment of a seedling tray.

FIG. 24 depicts a bottom perspective view of the embodiment of the seedling tray shown in FIG. 23.

FIG. 25 depicts an enlarged top view of the embodiment of the seedling tray shown in FIG. 23.

FIG. 26 depicts an enlarged bottom view of the embodiment of the seedling tray shown in FIG. 23.

FIG. 27 depicts a perspective view of another embodiment of the seedling tray.

FIG. 28 depicts a perspective view of the seedling tray shown in FIG. 23 disposed in a flat tray.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed may be resorted to by those skilled in the art, and that such modifications and variations are considered to be within the scope of this invention as defined by the appended claims.

Whenever a range is given in the specification, for example, a temperature range, a time range, or a composition or concentration range, all intermediate ranges and subranges, as well as all individual values included in the ranges given are intended to be included in the invention. It will be understood that any subranges or individual values in a range or subrange that are included in the description herein can be excluded from the claims herein.

It will be understood that, as used in the description herein and throughout the claims that follow, the meaning of “a”, “an”, and “the” includes plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising”, or “includes” and/or “including”, or “has” and/or “having”, or “carry” and/or “carrying”, or “contain” and/or “containing”, or “involve” and/or “involving”, “characterized by”, and the like are to be open-ended, i.e., to mean including but not limited to. When used in this disclosure, they specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used in the disclosure, “around”, “about”, “approximately” or “substantially” shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated.

As used in the disclosure, the phrase “at least one of A, B, and C” should be construed to mean a logical (A or B or C), using a non-exclusive logical OR. As used herein, the term “and/or” includes any and all combinations of one or more of the associated listed items.

Present system described herein features a seedling cube including a seedling tray and a cube lid assembly and their application. The seedling cube has structures improving ventilation of air and water for the seedlings grown inside the seedling cube. The seedling cube has better strength to withhold the weight of the soil and seedlings. Moreover, the seedling tray and cube lid are both stackable such that it effectively reduces the packaging volume. The cube lid is a transparent cover and is capable of providing slow and/or continuous drip irrigation evenly to all seedlings in the seedling tray.

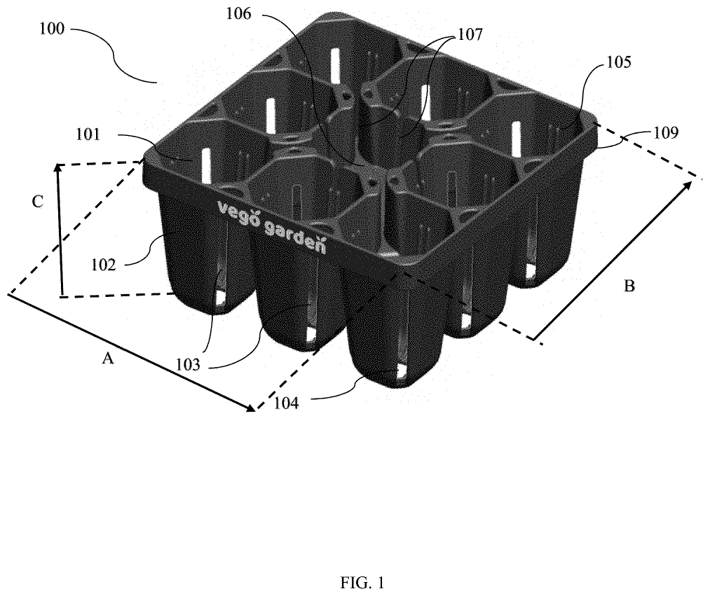

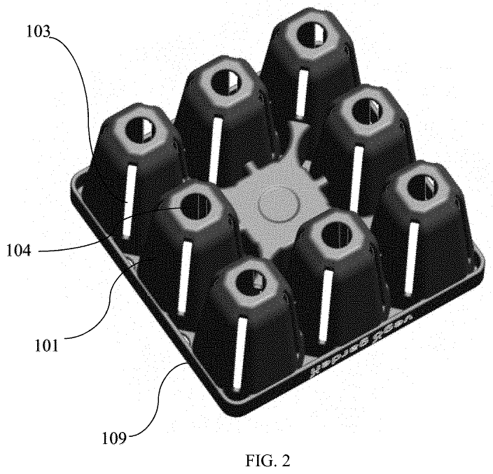

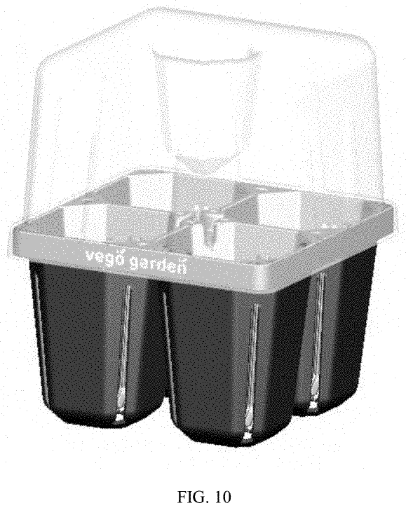

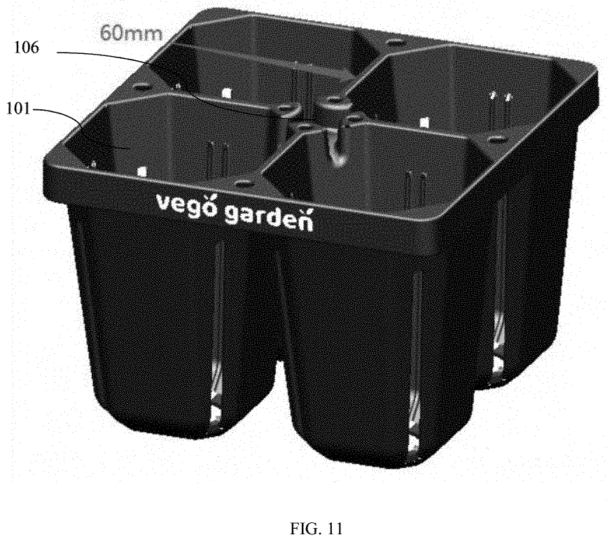

As shown in FIGS. 1-2, a seedling tray 100 has a plurality of cells 101. Each of the cells 101 contains a wall panel 102 peripherally enclosing a space for containing soil or medium for cultivation of one or more seedlings therein. In one embodiment, the seedling tray 100 has 8 cells 101 arranged in an array surrounding a branching table 106, as shown in FIGS. 1-2. In one embodiment, the seedling tray 100 has 4 cells 101 surrounding a branching table 106, as shown in FIGS. 10-11. In one embodiment, the seedling tray 100 has 76 cells 101 arranged in an array surrounding a plurality of the branching tables 106.

In other embodiments, the seedling tray 100 may has 1, 2, 3, 4, 5, 6, 7, 9, 10, 11, 12, 13, 14, 15, 16 cells, respectively. In one embodiment, the seedling tray 100 may has about 20, 25, 30, 35, 40, 45, 50, 55, 60, 65, 70, 75, 80, 85, 90, 95, 100 cells, respectively.

In one embodiment, each cell 101 has one or more air pruning slots 103 opened on the wall panel 102 to facilitate the air ventilation for the soil/medium and the seedlings in the cells 101. In one embodiment, the air pruning slot 103 is an elongated slot extending from the top rim of the cell 101 to the bottom of the cell 101, as shown in FIGS. 1-2. In another embodiment, the air pruning slot 103 comprising a plurality of dot slots arranged in a line extending from the top rim of the cell 101 to the bottom of the cell 101.

In one embodiment, the wall panel 102 forms a rectangular or square shape for the cell 101, and each corner of the cell 101 has an air pruning slot 103. In another embodiment, the wall panel 102 forms an octagon shape for the cell 101, and four out of eight sides of the cell 101 each has an air pruning slot 103, as shown in FIG. 1. In another embodiment, the wall panel 102 may form any shape for the cell 101, e.g. a circular shape or a triangular shape, and one or more air pruning slots 103 may locate at any position proper for facilitating the air and water ventilation.

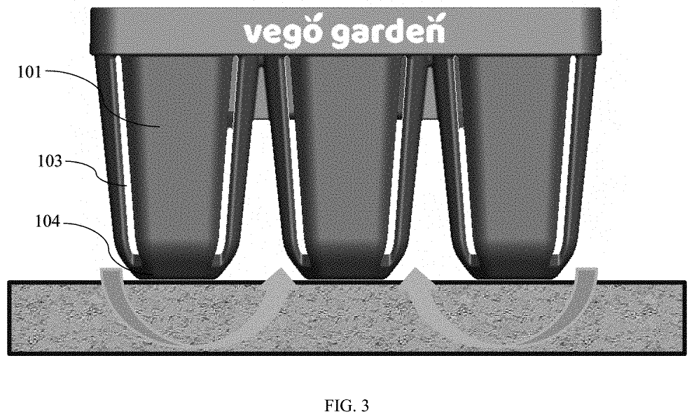

In one embodiment, the cell 101 has a drain hole 104 on the bottom of the cell 101. The drain hole 104 permits the excess water to be drained out of the cell 101 therefrom. As shown in FIG. 3, when the seedling tray 100 is placed on a flat surface such that the drain hole 104 is blocked by the flat surface, the air pruning slots 103 permit the excess water to be drained out of the cell 101 therefrom and permit the air ventilation of cells 101 therethrough. The drain hole 104 may have any shape proper for drainage of water. In one embodiment, as shown in FIGS. 1-2, the drain hole 104 is substantially circular.

In one embodiment, each cell 101 may further include a plurality of reinforce strips 105 locate on the wall panel 102. In one embodiment, the reinforce strips 105 locate on the inner surface of the cells 101. In another embodiment, the reinforce strips 105 locate on the outer surface of the cells 101. In one embodiment as shown in FIG. 1, each side of the cells, which does not have an air pruning slot 103, has a pair of the reinforce strips 105, extending from the top of the cells to the drain hole 104. The reinforce strips 105 enhance the strength of each cell 101, such that the capability of the cells 101 and seedling tray 101 to withhold the soil and water is significantly improved.

As shown in FIGS. 1, 4 and 11, the seedling tray 100 may further include a branching table 106 locating in the center of the seedling tray and is surrounded by the cells 101. The height of the branching table 106 is lower than the top rim of the cells 101, thus the branching table 106 forms a recess in the center of the seedling tray 100.

In one embodiment, the branching table 106 is in fluidly communication with one or more branching channels 107. Each of the branching channels 107 is connected to the branching table 106 on one end, and is connected to one or more cells 101 on the other end, such that the water and/or air may be circulated between the branching table 106 and the cells 101 via the branching channels 107.

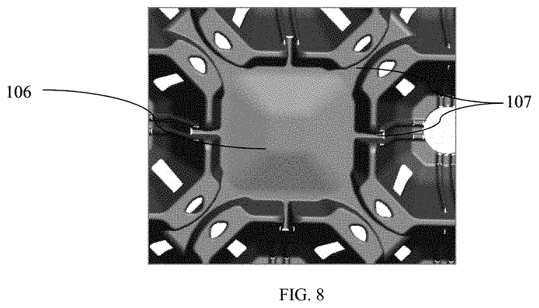

In one embodiment, the branching table 106 may include a surface with a raised table structure as shown in FIG. 8 such that when the water is received in the recess formed by the branching table 106, the water would automatically flow into the branching channels 107 due to the gravity. The branching table 106 has a surface structure which is higher in the central area and lower in the peripheral area such that the water would automatically flow from the central area to the peripheral area and then enters into the branching channel 107 therefrom due to the gravity. In another embodiment, the branching table 106 may have an arched top surface. In yet another embodiment, the branching table 106 may have a domed surface. In one embodiment, the branching table 106 has a concentric symmetrical structure. In one embodiment, the water received in the recess formed by the branching table 106 would flow to each and every branching channels 107 evenly.

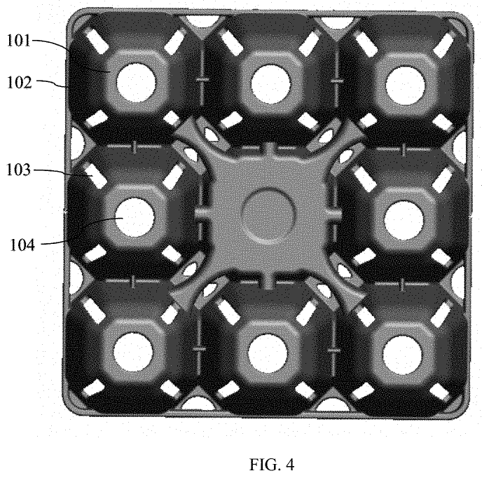

In one embodiment, the seedling tray 100 has a top peripheral rim 109 which provides structural strength to the seedling tray 100, preventing tearing and/or ripping of the cells 101. Moreover, as shown in FIG. 4, the balanced rib layout formed by the cells 101, the branching table 106, and branching channels 107 reduces total materials of the seedling tray 100 while maintaining overall structural strength of the seedling tray 100.

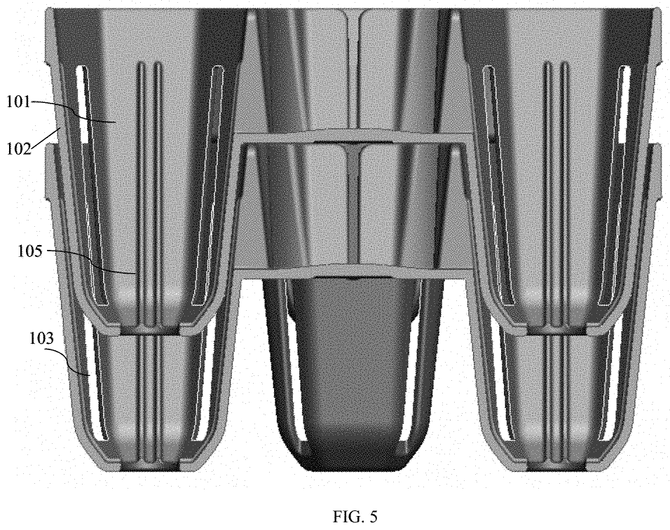

As shown in FIG. 5, the seedling tray 100 is stackable. That is, when a first seedling tray 100 is placed on top of the second seedling tray, the cells 101 of the first seedling tray would be at least partially received in the cells of the second seedling tray, while the branching table 106, the branching channels 107, and top peripheral rim 109 of the first seedling tray would be aligned with the branching table 106, the branching channels 107, and top peripheral rim 109 of the second seedling tray. The stackable feature of the seedling tray 100 significantly reduces the packaging volume.

As shown in FIG. 1, the width of the seedling tray 100 is shown by arrow A, the length of the seedling tray 100 is shown by arrow B, and the height of the seedling tray 100 is shown by arrow C. In one embodiment, the seedling tray 100 has a width ranges between 2 inch to 60 inch, a length ranges between 2 inch to 60 inch, and a height ranges between 2 inch to 60 inch. In one embodiment, the the seedling tray 100 has a width ranges between 5 inch to 24 inch, a length ranges between 2 inch to 24 inch, and a height ranges between 5 inch to 24 inch. In one embodiment, the the seedling tray 100 has a width ranges between 8 inch to 20 inch, a length ranges between 8 inch to 20 inch, and a height ranges between 8 inch to 20 inch. In one embodiment, the the seedling tray 100 has a width about 5 inch, and a length about 5 inch. In one embodiment, the the seedling tray 100 has a width about 10 inch, and a length about 20 inch.

In one embodiment, a seedling tray 100 having 4 cells has substantially same dimension with a seedling tray 100 have 8 cells, as shown in FIGS. 10-11.

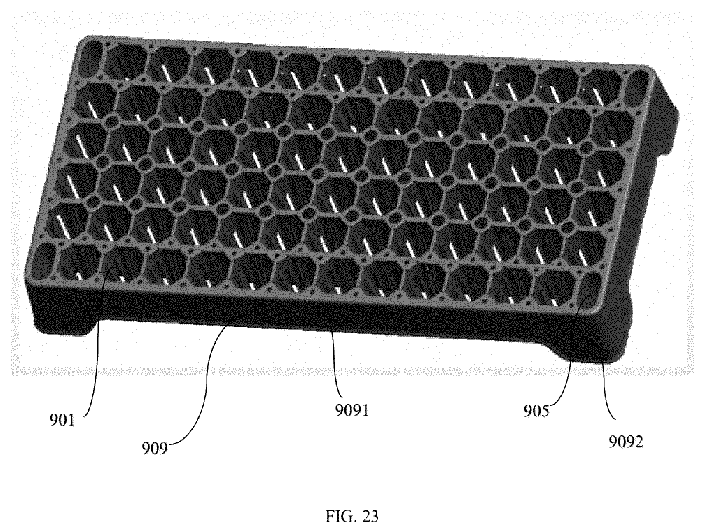

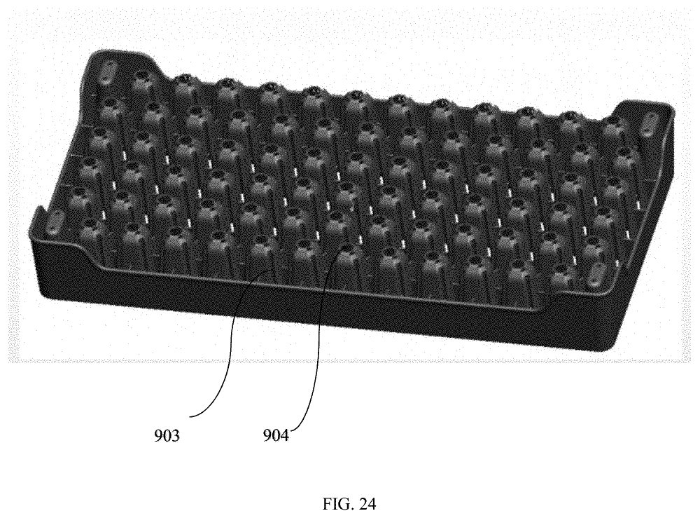

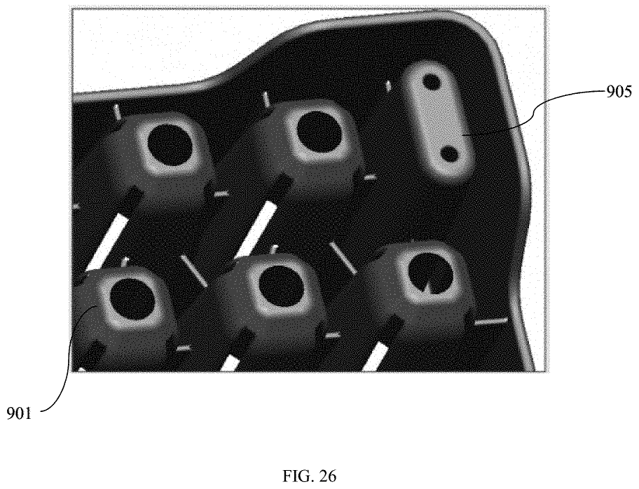

FIGS. 23-27 show another embodiment of a seedling tray 900. In particular, the seedling tray 900 includes a tray frame 901 having a plurality of frame feet 9092 supporting the frame from the surface and frame bridges 9091 connecting the frame feet 9092. A plurality of cells 901 locates inside the tray frame 901.

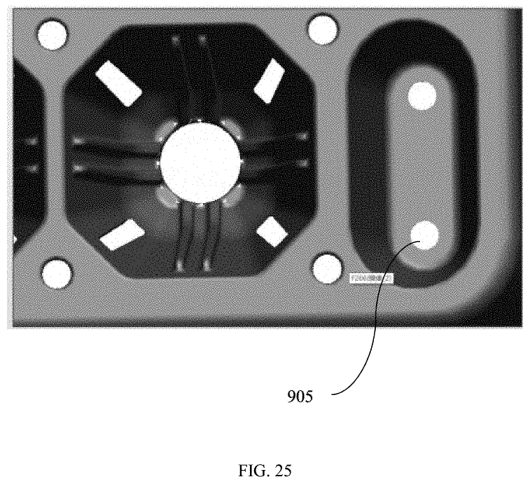

The cells 901 also includes air pruning slots 903 on the wall of the cells 901 and drain hole 904 on the bottom part of the cells 901, similar as seedling tray 100 described above, as shown in FIG. 25.

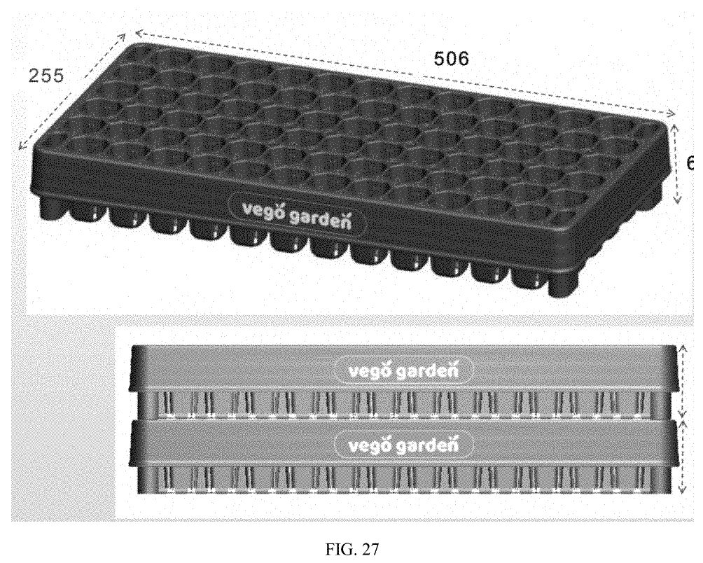

In one embodiment, the seedling tray 900 also included a plurality of supporting recess 905. In one embodiment, the supporting recess 905 locates in adjacent to the frame foot 9092. As shown in FIG. 27, the supporting recess 905 of a first seedling tray 900 receives the bottom part of the frame foot 9092 of a second seedling tray, when the second seedling tray 900 is disposed above the first seedling tray, such that the seedling tray 900 is stackable.

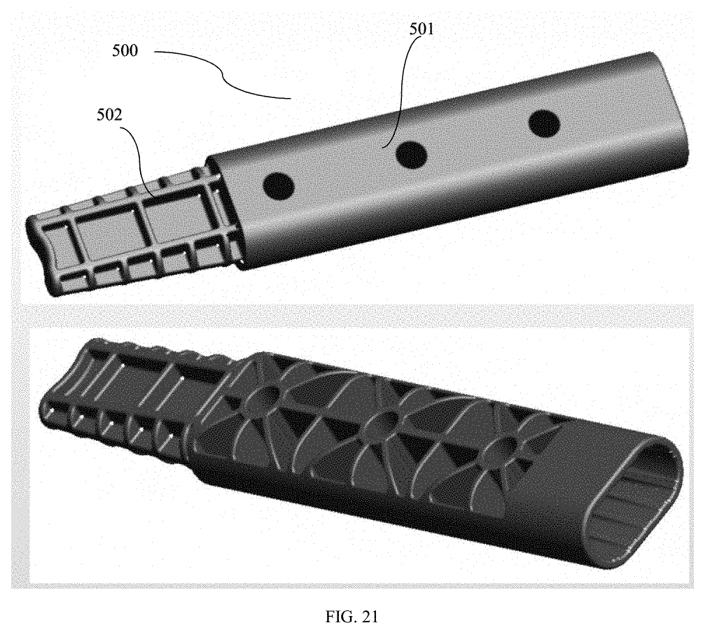

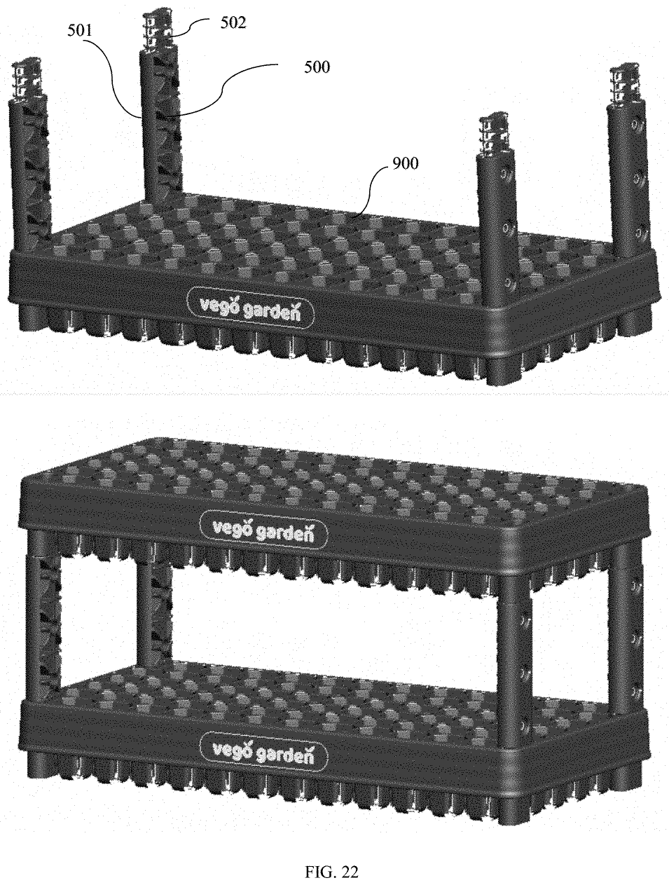

FIG. 21 shows an embodiment of a supporting leg 500. The supporting leg 500 comprising a leg 501, and a tapered end 502. In one embodiment, the diameters of the cross section of the tapered end 502 is smaller than the diameters of the cross section of the leg 501. As shown in FIG. 22, the supporting leg is received in the supporting recess 905 of the seedling tray 900 on one of its end, and is received by the bottom part of the frame foot 9092 on the other end. In one embodiment, as shown ion FIG. 22, the tapered end 502 is received by the bottom part of the frame foot 9092, and the other end on the leg 501 is received on the the supporting recess 905 of the seedling tray 900.

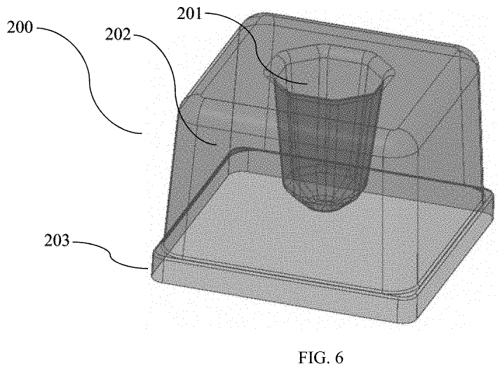

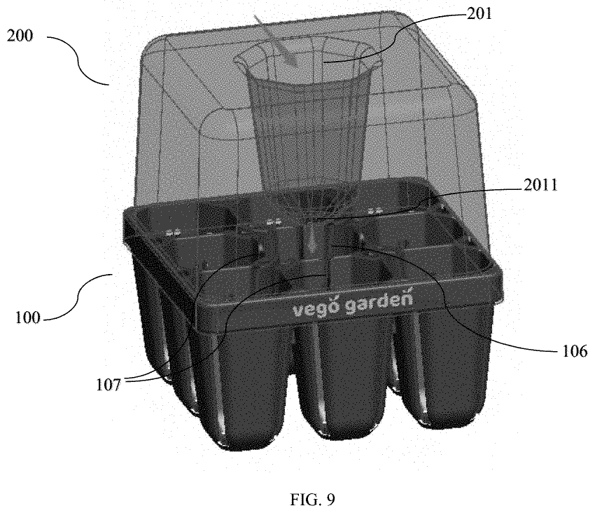

As shown in FIG. 6, a cube lid 200 may be disposed on top of the seedling tray 100 so as to provide better irrigation and humidity control for the seedlings grown in the seedling cube. The cube lid 200 includes a water storage tank 201, a lid body 202, and a bottom rim 203. As shown in FIG. 9, when the cube lid 200 is disposed on top of the seedling tray 100, the top peripheral rim 109 of the seedling tray 100 is received by the bottom rim 203 of the cube lid 200.

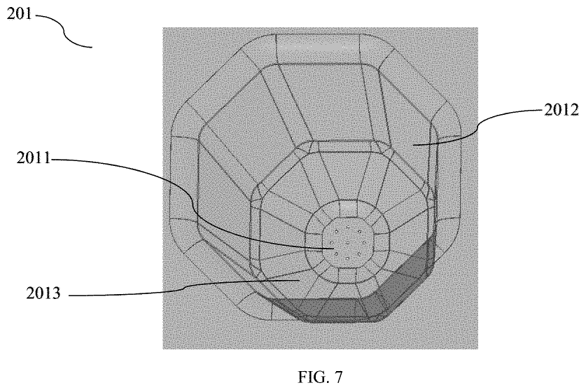

As shown in FIGS. 7-9, the water storage tank 201 includes a plurality of the water holes/slits 2011 on the bottom of the water storage tank 201, such that the water in the water storage tank 201 would drip onto the branching table 106 of the seedling tray 100 when the cube lid 200 is disposed on top of the seedling tray 100. The dripping of the water is limited by the size and amount of the holes/slits 2011 such that the water storage tank 201 provides a slow and/or continuous irrigation to the seedlings inside the seedling tray 100.

In one embodiment, the water storage tank 201 also includes a slope 2013 for directing the water received in the water storage tank 201 to the holes/slits 2011. In one embodiment, the water storage tank 201 also includes a surrounding wall 2012 for containing excess water received in the water storage tank 201, such that the cover lid 200 may provide slow and continuous irrigation to the seedlings in the seedling tray 100.

In one embodiment, the cube lid 200 is stackable. That is, when a first cube lid 200 is disposed on top of a second cube lid 200, the water storage tank 201 of the first cube lid 200 would be at least partially received in the water storage tank 201 of the second cube lid 200, while the cube lid 202 of the first cube lid 200 would receive at least part of the lid body 202 of the second cube lid 200.

In one embodiment, the cover lid 200 includes transparent materials e.g., plastic, glass, and etc., permitting the sunlight passing through. In one embodiment, the cover lid 200 may include materials of a particular color such that only lights with certain wavelengths may pass through the cover to reach to the seedlings.

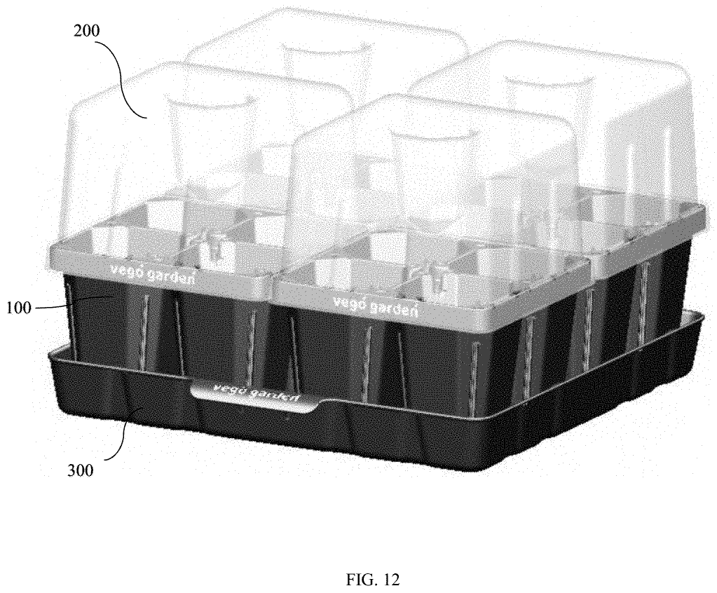

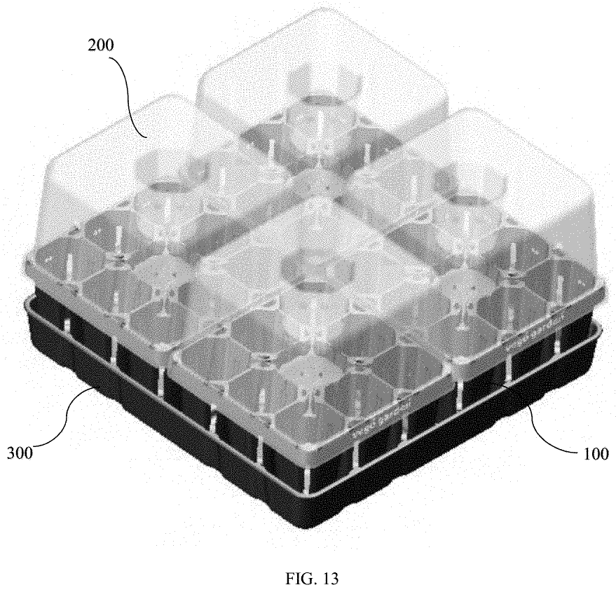

In one embodiment, the seedling cube further includes a flat tray 300 which is disposed under the seedling tray 100 for collecting the soil falling out of the seedling tray 100, a s shown in FIGS. 12-13. In one embodiment, the flat tray 300 collects the water drained out of the seedling tray 100. In one embodiment, the user may water the seedlings by watering from the flat tray 300 such that the water wicking into the seedling tray 100.

In one embodiment, the flat tray 300 has a width ranges between 2 to 60 inch, and a length ranges between 2 to 60 inch. In one embodiment, the flat tray 300 has a width about 10 inch, and a length about 10 inches. In one embodiment, the flat tray 300 has a width about 10 inch, and a length about 20 inches. In one embodiment, the flat tray 300 has a width about 20 inch, and a length about 10 inches.

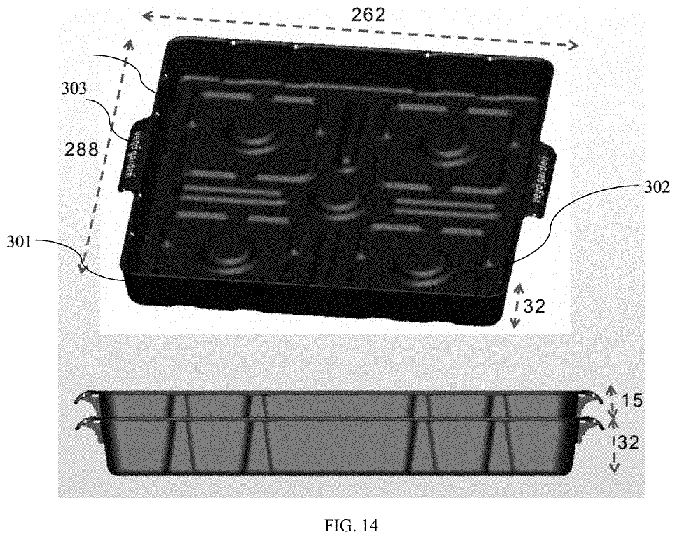

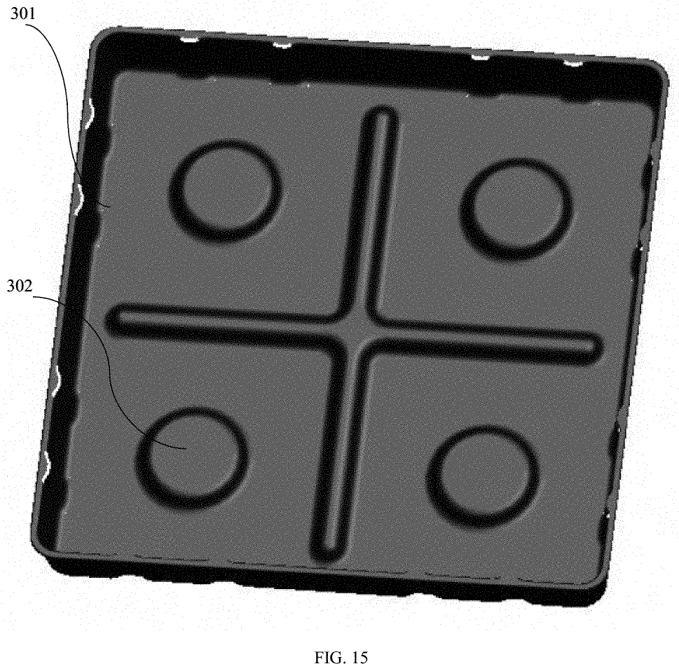

As shown in FIGS. 14-15, the flat tray 300 includes a tray pan 301, a plurality of cube wells 302 in the 301 for receiving the seedling tray 100, and one or more tray pan holders 303. In one embodiment, the flay tray 300 is stackable as shown in the lower panel of FIG. 14. In one embodiment, the flat tray may receive one seedling tray 100. In one embodiment, the flat tray may receive four seedling trays 100. In one embodiment, the flat tray may receive any number of seedling trays 100 between 1 to 100.

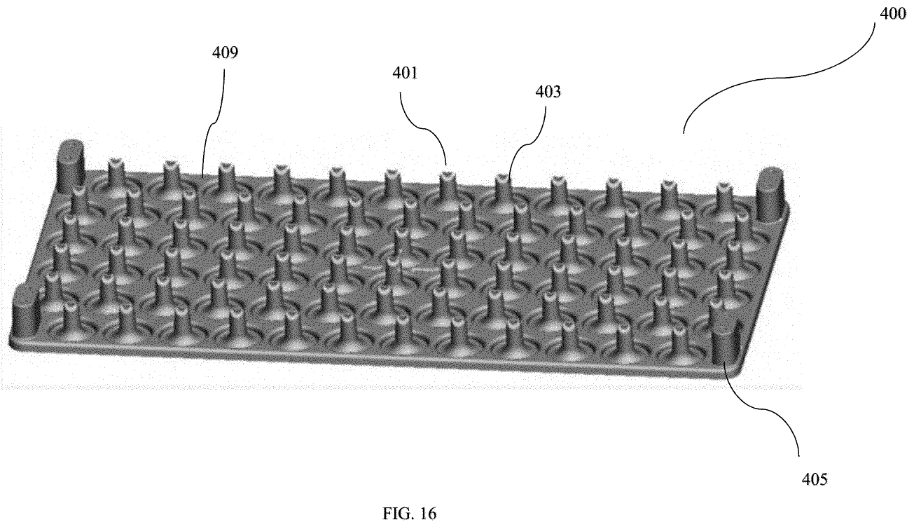

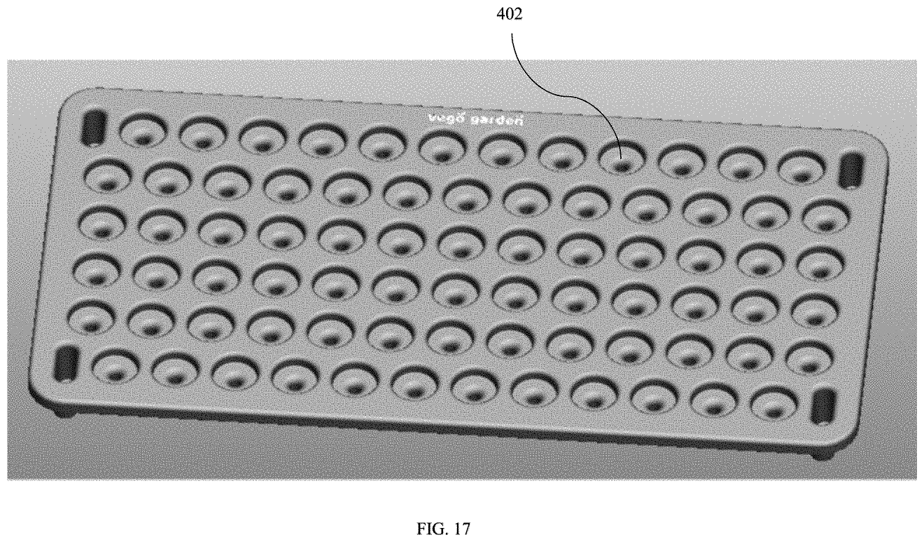

FIGS. 16-20 shows an embodiment of a seeder/popper panel 400 for inserting seeds into the soil in the cells 901 of the seedling tray 900. The seeder/popper panel 400 includes a plurality of seeder/popper unit 401 arranged on a base plate 409 in a pattern same as the pattern of cells 901 arranged in the seedling tray 900. In one embodiment, the seeder/popper panel 400 further includes a plurality of panel feet 405. The seeder/popper unit 401 includes a unit protrusion 403 on one surface of the base plate 409, and a unit funnel on the other surface of the base panel 409. The unit funnel 402 has a funnel shape for receiving seeds. The unit protrusion 403 has a hole on the end permitting seed received via the unit funnel 402 to pass through.

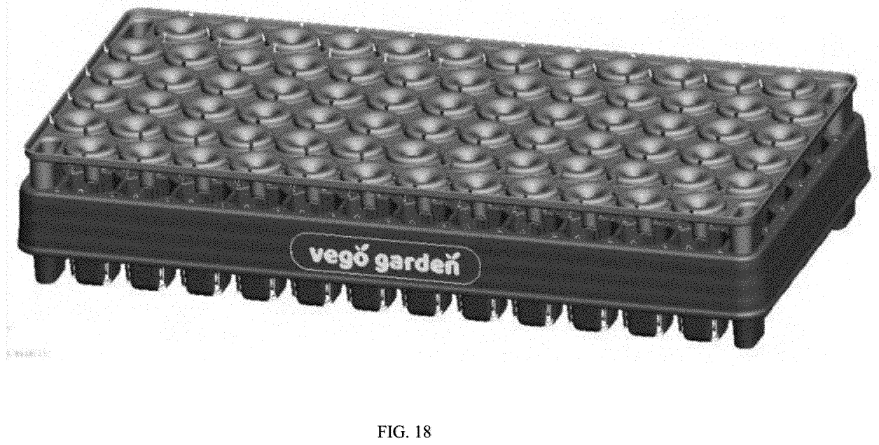

FIG. 18 shows the application of the seeder/popper panel 400 in association with the seedling tray 900. In particular, the the seeder/popper panel 400 is placed above the seedling tray 900, with each seeder/popper unit 401 matched with each cells 900 of the seedling tray 900. Once the seeder/popper units 401 and cells 900 are matched, the seeder/popper panel 400 is pressed down with the seeder/popper unit 401 inserting into the soil in the cells 900, and a recess is formed in the soil in each of the cells 900.

Thereafter, the seeds are placed into the unit funnels 402 where the seeds passed through and enter into the recesses formed in the soil in the cells 900. Once the seeds are settled in the soil, the seeder/popper panel 400 is removed. The user may then cover the seeds in the cells 900 with top soils.

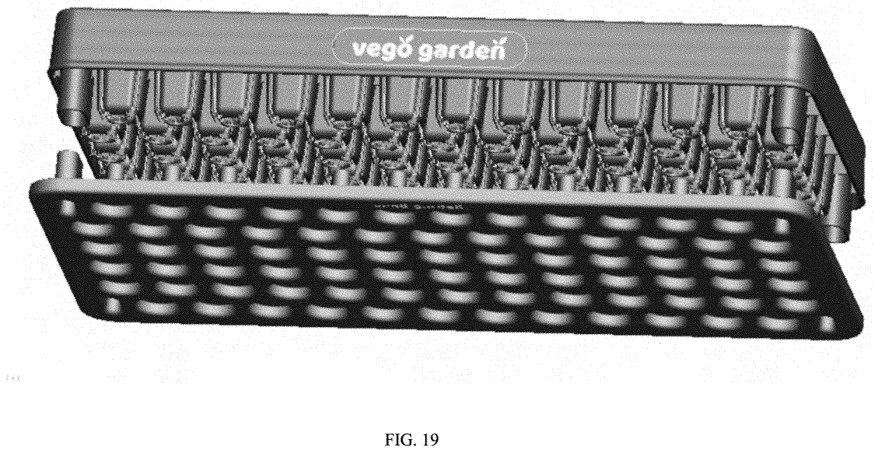

As shown in FIG. 19, once the seedlings are grown in the seedling tray and need to be moved to garden bed, the seeder/popper panel 400 would be placed under the seedling tray 900 with each of the seeder/popper unit 401 matched with each of the cells 900 of the seedling tray 900. Once the seeder/popper units 401 and cells 900 are matched, the seeder/popper panel 400 is pressed up such that each of the unit protrusion 403 of the seeder/popper unit 401 is inserted into each of the cells 900 via the drain hole 904. The seedlings together with the soil would then be popped out of the cells 900.

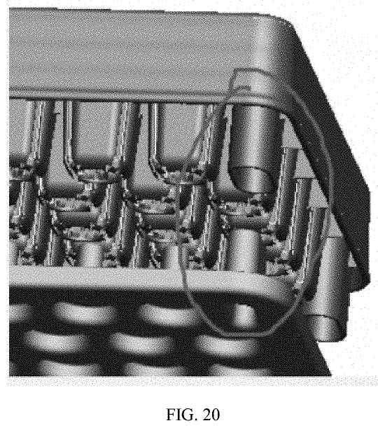

In one embodiment, when the seeder/popper panel 400 is used for popping the seedlings out of the seedling tray 900, the panel foot 905 is received in the bottom part of the frame foot 905 of the seedling tray 900, as shown in FIG. 20.

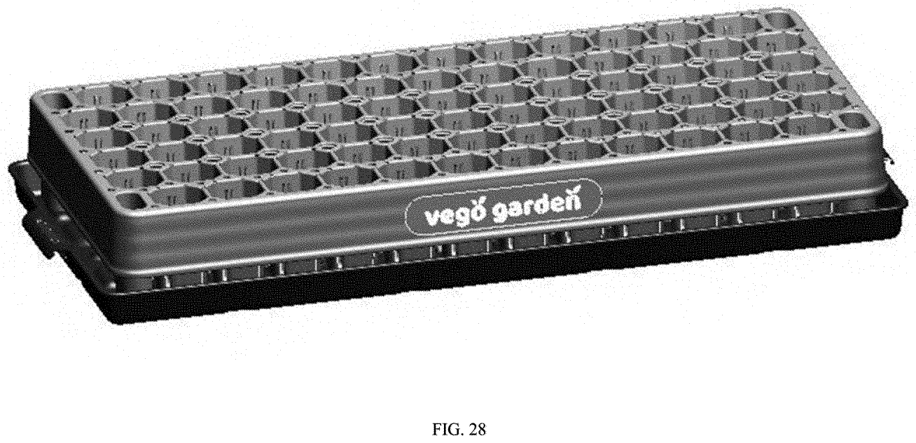

As shown in FIG. 28, the seedling tray 900 may also be disposed in a flat tray 300 having a dimension proper for receiving the bottom part of the seedling tray 900. The flat tray 300 collects the soil falling out of the seedling tray, and provides a wicking function for collecting excess water when the soil is overly wet and watering the soil when the soil is dry.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A seedling cube for growing seedlings, the seedling cube comprising:
a seedling tray having a plurality of cells; and
a cube lid which is configured to be disposed on top of the seedling tray.

2. The seedling cube according to claim 1, wherein each of the cells has at least one air pruning slot on wall of the cell.

3. The seedling cube according to claim 2, wherein
the air pruning slot comprises an elongated-shape hole extending from top portion of the cell to bottom portion of the cell.

4. The seedling cube according to claim 2, wherein
the air pruning slot comprises a plurality of dot-shape holes arranged in a line extending from top portion of the cell to bottom portion of the cell.

5. The seedling cube according to claim 3, wherein
each of the cells has four air pruning slots, wherein each of the air pruning slots locates near a corner of the cells.

6. The seedling cube according to claim 2, wherein
each of the cells further comprises at least one reinforce strip on the wall.

7. The seedling cube according to claim 2, wherein
each of the cells further comprises a drain hole on the bottom portion of the cell.

8. The seedling cube according to claim 2, wherein
the seedling tray further comprises a branching table in the center of the seedling tray and is surrounded by the cells; wherein the height of the branching table is lower than the height of the cells such that a recess space is formed above the branching table for receiving water.

9. The seedling cube according to claim 8, wherein
the seedling tray further comprises at least one branching channel, wherein the branching channel is in fluid communication with the branching table on one of its ends, and is in fluid communication with at least one cell on the other of its ends.

10. The seedling cube according to claim 9, wherein
the branching table is raised in the central area of its top surface such that water received on the branching table would automatically flow into the branching channel due to gravity.

11. The seedling cube according to claim 10, wherein
the branching table provides slow and continuous irrigation to the seedlings in the cells.

12. The seedling cube according to claim 10, wherein
the top surface of the branching table is symmetrical such that the water received on the branching table is configured to be evenly distributed into all the cells.

13. The seedling cube according to claim 9, wherein
the cube lid comprises a water tank storage receiving water and a lid body.

14. The seedling cube according to claim 13, wherein
the water tank storage of the cube lid is configured to be vertically aligned with the branching table of the seedling tray when the seedling tray and the cube lid are coupled together.

15. The seedling cube according to claim 14, wherein
the water tank storage comprises a plurality of slits on its bottom portion, wherein the water drips onto the branching table of the seedling tray through the plurality of slits on the water tank storage.

16. A stackable seedling tray, comprising:
a plurality of cells,
a branching table in the center of the seedling tray and surrounded by the cells.

17. The stackable seedling tray according to claim 16, wherein
each of the cells has at least one air pruning slot on wall of the cell.

18. The stackable seedling tray to claim 17, wherein
the air pruning slot comprises an elongated-shape hole extending from top portion of the cell to bottom portion of the cell.

19. The stackable seedling tray according to claim 16, wherein
each of the cells further comprises at least one reinforce strip on the wall.

20. The stackable seedling tray according to claim 16, wherein
each of the cells further comprises a drain hole on the bottom portion of the cell.

21. The stackable seedling tray according to claim 16, wherein
the seedling tray is stackable.
